(19) United States
(12) Patent Application Publication
(10) Pub. No.: US 2015/0333622 A1
(43) Pub. Date: Nov. 19, 2015

(54) (PHOTO)VOLTAIC SYSTEM AND INTELLIGENT CELL CURRENT CONVERTER (IC3) TECHNOLOGY

(71) Applicant: Roeca B.V., Enschede (NL)

(72) Inventors: Callistus Franciscus Antonius Peters, Enschede (NL); Martin Koster, Enschede (NL); Roeland Cornelis Huiberts, Enschede (NL)

(21) Appl. No.: 14/811,231

(22) Filed: Jul. 28, 2015

Related U.S. Application Data
(63) Continuation of application No. PCT/NL14/50046, filed on Jan. 29, 2014.

(30) Foreign Application Priority Data
Jan. 29, 2013 (NL) 2010197

(51) Int. Cl. H02M 3/04; H02J 7/35; H02S 40/38; H02J 1/14; H02S 20/26; H02S 40/32

(52) U.S. Cl. CPC H02M 3/04; H02S 20/26; H02S 40/32; H02S 40/38; H02J 1/14; H02J 7/35

(57) ABSTRACT

The present invention is in the field of Voltaic systems, specifically PV-systems, having improved functionality, building elements comprising said system, and objects comprising said systems.

Such systems are typically not integrated into for example buildings. Rather such systems are placed on top of for example buildings, or the like, making these kinds of systems are visually unattractive.

### CROSS REFERENCE TO RELATED APPLICATIONS

This application is a continuation application of the International Application with serial number PCT/NL2014/050046, filed on Jan. 29, 2014, which in turn is a continuation of the Dutch Patent Application with Serial number NL2010197, both entitled “(Photo)voltaic system and Intelligent cell current converter (IC³) technology”, to Roeca B. V., Enschede, the Netherlands, filed on Jan. 29, 2013, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHT MATERIAL

Not Applicable.

### FIELD OF INVENTION

The present invention is in the field of voltaic systems, specifically (photo)voltaic systems, building elements comprising said system, and objects comprising said systems providing improved electrical energy conversion.

### DESCRIPTION OF RELATED ART

In the field of energy conversion PV-systems are known. These systems generally use a PN-junction to convert solar energy to electricity.

A disadvantage of such a system is that the conversion per se is not very efficient, typically, for Si-solar cells, limited to some 20%. Even using very advanced PV-cells, such as GaAs cells, the conversion is only about 30%. Inherently these systems are limited in their conversion.

Further these systems are relative expensive to manufacture.

Even further, such systems are typically not integrated into for example buildings. Rather such systems are placed on top of for example buildings, or the like, making these kind of systems visually unattractive.

Systems are typically not optimized in terms of energy production, use of energy, availability of energy, etc., especially in view of consumption patterns of a building. Integration with for instance other household applications is otherwise typically not provided.

Systems typically also need to be installed. Such installation is complex in nature, requires piping and/or cabling, and is expensive. Also, complex mounting systems for PV systems onto buildings result in increased failure rates and increased installation costs.

Integration of systems is typically also in its initial stage. Not many applications are available yet.

So existing PV systems show huge power output losses, and significant quantities of generated power are not usable because of e.g. too low power at low light conditions, due to dirty cells, and shading, effecting the total output of a PV-module. Using a micro inverter or the like does not solve this problem.

In general similar problems exist with voltaic systems.

Various documents recite energy conversion systems. WO2007082168 (A2) recites a device and method for harvesting, generating, storing, and delivering energy to a load, particularly for remote or inaccessible applications. The device preferably comprises one or more energy sources, at least one super-capacitor, at least one rechargeable battery, and a controller. The charging of the energy storage devices and the delivery of power to the load is preferably dynamically varied to maximize efficiency. A low power consumption charge pump circuit is preferably employed to collect power from low power energy sources while also enabling the delivery of higher voltage power to the load. The charging voltage is preferably programmable, enabling one device to be used for a wide range of specific applications. The components used are relatively expensive and do not solve all of the problems mentioned.

EP 2 200 151 A1 recites a photovoltaic system for generating an output voltage which is essentially uninfluenced by varying irradiation, the photovoltaic system comprising at least one photovoltaic unit comprising two photovoltaic sources. The system is characterized amongst others in that the photovoltaic unit comprises two voltage adding arrangements each having a first route comprising a voltage source and a second route constituting a voltage source bypass. Therein only one battery is used per current converter, which is considered a voltage source. Such does not relate to a voltage adder. Further the system does not describe a comparator, only a means for comparing output power to an instantaneous need. The system further suffers from typical prior art problems and does not provide the advantages of the present invention.

US 2012/223583 A1 recites switched capacitor multilevel output DC-DC converters that can be used as panel integrated modules in a solar maximum power point tracking system. The system can also include a central input current-controlled ripple port inverter. The system can implement per panel MPPT without inter-panel communication, electrolytic capacitors or per panel magnetics. A Marx converter implementation of the switched capacitor module is studied. Average total efficiencies (tracking conversion) greater than 93% can be achieved for a simulated 510 W, 3 panel, DC-DC system. The DC-DC converters are not applied per individual cell. As a consequence the system can e.g. not compensate for shading of (a part of) the panel.

Thus there still is a need for improved energy conversion system, which system overcomes one or more of the above disadvantages, while at the same time not jeopardizing other favourable aspects of energy conversion.

### BRIEF SUMMARY OF THE INVENTION

The present invention relates to a voltaic system, having Intelligent cell current converter (IC³) technology incorporated therein, in an example adapted to be attached to a surface or forming part thereof, comprising one or more voltaic units, one or more IC³ circuits, and a optionally a wireless power transmitter, a building element comprising such a system, as well as a technological object comprising said system, use of said system or element, IC³ circuits and a voltaic multiplying current converter (VMC²) module comprising said IC³ circuits. In an example the present system is highly symmetrical.

The one or more voltaic units provide electrical power input. Examples thereof are photovoltaic units, each unit comprising one or more solar cells.

The IC³ technology is aimed at optimizing output in terms of electrical energy, by upgrading energy provided by e.g. a PV-system, wherein the upgraded power can be harvested at a higher efficiency, that is with fewer losses.

The IC³ circuits and voltaic multiplying current converter (VMC²) module and converter are aimed at maximizing power output and at harvesting power starting at very low levels. Typically a voltaic system is not optimised in terms of power output en power generation. Such is especially important as many voltaic units operate at sub-optimal conditions, thereby not generating any power or at the most a very low amount. Thereto the IC³ circuit comprises voltage adders with charge siphon devices for collecting charge, operable at very low voltage, current adders, operable at low current. It is noted that such a charge siphon device per se does not relate to a battery or the like. One or more switches or the like are provided, the switches connecting the one or more voltage adders alternately to the voltaic units, as well as providing the option to connect or disconnect components of the voltaic system, components such as voltaic unit, voltage adder, IC3, charge siphon device, and comparator. The switch may be switched once a certain typically pre-set voltage, current, or charge is reached. As such the number of e.g. voltage adders in view of the number of voltaic units may be optimised. The voltage adder adds voltage, the current adder adds current, whereas voltage and current are provided by the voltaic unit. In an example the voltage adder is in electrical contact with the voltaic unit, whereas the current adder is in electrical contact with the voltage adder, thereby being in indirect contact with the voltaic unit. In a further example the voltage adder and current adder are interchanged with respect to the previous configuration. Also a comparator is present, the comparator e.g. comparing output voltage of the voltaic units with a threshold value and optionally controlling power harvesting. The threshold value may be provided by one voltaic unit, e.g. a unit operating under sub-optimal conditions. It is noted that the present comparator is use to optimize yield of electrical energy, by comparing in view of varying electrical input. An electrical accumulator may be provided for storing charge, such as a battery, a capacitor, etc.

Amongst others the present system collects all generated power and converts generated power into usable power. The IC³ circuit makes PV systems insensitive for shading effects, causing detrimental effects in e.g. a series of cells, apart from cells not providing a current due to lack of solar radiation. Furthermore at low light conditions the IC³ circuit electronics converts non-usable power in usable power. By using the IC³ circuit electronics the power generation of a PV systems increases 10-20% in comparison to the conventional PV systems and 5-15% in comparison to PV systems with micro-inverters. In an example charge siphon devices, such as a capacitor, are not fully loaded, but partly. Typically the present charge siphon device is loaded to about 63% of its maximal loading capacity. The IC³ circuit is very efficient >95%, typical 98% under all conditions. The IC³ circuit electronics can be produced at low cost for economy of scale quantities. The IC³ circuit is very robust since it uses conventional electrical components with a proven stability at extreme climate conditions over time (>20 years). As indicated throughout the description the IC³ circuit is applicable to in principle any voltaic system, such as a PV-system.

In an example the present system is an easy to install (Plug and Play) PV mounting system based on Wireless Power Transfer (WiPoT) approach at high conversion efficiencies. Using the WiPoT one end of the transmission module (typically the primary winding) may be located in or attached to the voltaic unit, whereas another end (typically the secondary winding) may be attached to e.g. the power grid. For sake of efficient installation magnets may be provided, such as one at each end, for establishing (electro-mechanical) connection between a first and second end of the WiPoT. The system can be used as stand-alone system (with e.g. electrical energy storage means) and as (part of) a grid, being connected to buildings, or a micro grid.

By using the present voltaic system, in particular a PV-system, a user thereof becomes less dependent of energy suppliers and its fluctuating energy prices. In fact a (largely) stable pricing is established. It is noted that the return of investment costs due to reduced electricity costs is with current prices already within reasonable reach, and with the present system, especially when building integrated, a profitable business case is being established.

The present system can be placed on a building, e.g. on a roof or a wall thereof, the roof and wall forming a surface, or be part thereof, e.g. a roof tile. Likewise the present system can form part of larger PV-systems. The present system can also form a part of a further product, such as low power devices, e.g. a surface of a mobile phone, and as such be (spatially) integrated to some extent. By largely integrating the present system into e.g. a building it may become more aesthetically attractive. Even further, integration in novel or refurbished buildings can reduce the costs thereof as the present system may have more than one function, e.g. conversion of light into energy and protection of a building against influences of the environment.

The present IC³ circuit is adapted to gather electrons in a relative broad power range, starting at a relatively low power. Thereby e.g. the efficiency, total output (over e.g. a year), threshold, performance in non-optimal weather conditions (cloudy weather) are improved significantly.

The present wireless power transmitter provides for lower costs for the system, as no or less cables are needed, maintenance is reduced, and lower costs of installation, e.g. because a place-and-click system may be used, such as roof and wall systems.

As such the present invention overcomes one or more of the above problems and/or disadvantages.

Various elements of the present apparatus as well as advantages will be discussed below in detail.

### DETAILED DESCRIPTION OF THE INVENTION

In a first aspect the present invention relates to a voltaic system according to claim 1. In a preferred example the present invention relates to a photovoltaic unit. However, in principle the invention is applicable to any e.g. in electrical terms similar, voltaic unit. As such the present invention relates to such voltaic units in general.

The IC³ circuit comprises one or more voltage adders, two or more first charge siphon devices per unit, preferably 2-100 siphon devices per unit, such as 4-50 siphon devices per unit, wherein the one or more first siphon devices are electrically connected in series to one and another. Therewith a voltage is multiplied by a first factor being in the example above from 2-100, assuming the same charge siphon devices are used. It is noted that by switching, e.g. by using more or less charge siphon device, per IC³ circuit a different multiplying factor may be obtained, the factor being from 2-100. In an idle mode the first factor may also be 1.

By introducing a voltage adder a voltage output of a (photo)voltaic unit (source) can be increased. As such e.g. 12 V, 24 V, 240 V and 400 V output can be generated. Likewise a current adder may be introduced, such as when adding the current, such as of at least 2 parallel sources. In both cases such is established preferably using a Maximum Power Point Tracker. Therewith an optimum is created in terms of power output

The IC³ circuit may comprise at least two charge siphon devices per unit, such as a capacitor, preferably having a relatively small capacitance of e.g. 1-100 nF, such as 2-50 nF. The module preferably operates at a power of less than 1 mW, more preferably less than 0.5 mW, even more preferably less than 0.25 mW, such as at about 0.1 mW. In an example the IC³ circuit has a power usage of less than 400 μW and a shutdown current of 400 μA.

Therewith e.g. parasitic power losses are reduced significantly to about 10⁻⁶-10⁻² of the output, depending on operating conditions.

The present invention provides as a consequence a system with a relatively high internal capacitance. Therewith in principle a relatively high storage capacity is provided as well.

Contrary to many prior art systems energy can now be harvested at a PV-cell level. Such provides huge advantages, at minimal extra costs.

In an example of the (photo)voltaic system further comprises a device for wireless transmission of energy, preferably electromagnetic energy, which device comprises a primary and a secondary coil or winding, and optionally a generator/oscillator. Therein the primary winding is electrically coupled to the one or more (photo)voltaic units or is in an idle mode, the secondary winding is coupled to one or more of a load device and power grid, the primary winding is located at a first side of the surface and the secondary winding is located at a second side of the surface. As such electrical energy is transferred from a first side of the surface, e.g. outside a building, to a second side of the surface, e.g. inside a building. As a consequence a reliable means for transfer is provided, having a high efficiency, e.g. of more than 95%, and no need for extra cabling. Examples of the present system have already achieved coupling factors of >99.98%.

The one or more (photo)voltaic units, and one or more of IC³ circuit and wireless power transmitter are adapted to be in electrical contact with one and another or to be idle. In other words the unit, module and transmitter may be in an active mode that is in electrical contact, thereby transferring energy, or in idle mode, that is not in electrical contact. Components or parts thereof can be switched “on” and “off”. Thereto one or more switches and a comparator are provided in the present system. The comparator e.g. compares voltage and current of a number (or all) of voltaic units, and likewise of first and second series of voltaic units, such as of PV-cell strings, and optimises settings of switches in terms of power output.

In an example the (photo)voltaic system further comprises one or more of various controls, an optimized energy collecting unit operable at very low voltage, as well as an energy transfer unit, using wireless technology, a timer, a collector cell, a display, and a processor.

In an example the PV-unit comprises an optically transparent photovoltaic unit, such as a Dye Solar Cell (DSC), which unit comprises a first contact, a second contact, a chamber, which chamber comprises a first and second component, which first and second component are adapted for converting radiation into direct current electricity, which chamber has at least 20% optical transmittance, preferably at least 30% optical transmittance. An advantage is that some or most light can be transmitted, and the PV-system can then also function as an optical window. In bright light conditions, such as in summer, the PV-system then also functions as a shield; even further the optical characteristics of the PV-system may be varied, e.g. transmittance may vary depending on requirements.

If e.g. a roof tile is used, the PV-unit may follow the shape of the roof tile, i.e. be bend.

In an example the (photo)voltaic unit comprises 1-10 (photo)voltaic cells, preferably 1-5 (photo)voltaic cells, such as 2-4 (photo)voltaic cells. In principle a unit may comprise any number of cells. Preferably 2 or more cells form a unit, e.g. as one module and one transmitter per unit are sufficient. However, preferably not too many cells form a unit, e.g. as efficiency of transmission may drop at higher voltages. The units and cells may be connected in series and/or in parallel. As such large strings of cells and units may be formed. In case of a roof tile e.g. two cells form one unit, such as having an area of 5×10 cm2 per cell, wherein a roof tile comprises 1-4 units.

In an example the IC³ circuit further comprises one or more of a power supply (U5), a controller, a timer, a collector cell, a display, a module for converting a constant current and variable voltage to a variable current and a constant voltage, such as a low drop out (LDO) module, an inverter, and a processor, and/or wherein the (IC³) circuit comprises 2^{m} charge siphon devices, wherein m is selected from {2;10}, preferably from {3;9}, such as {4;8}. The power supply may be provided e.g. in stand-alone application, in order to provide the IC³ circuit with (start-up) power. The power supply may also be used to provide power to further components of the IC³ circuit, such as timer, controller, etc. The controller is aimed at optimizing power output e.g. by switching connections between (individual) voltage adders and voltaic units, by controlling power supply to e.g. a grid, etc. The controller and comparator may be integrated into one component. The processor is aimed at calculating optimal situations under given boundary conditions, comparing boundary conditions, e.g. with a threshold, controlling power harvesting, etc. Also an AD-converter may be provided. Further a module for converting a constant current and variable voltage to a variable current and a constant voltage, such as a low drop out (LDO) module, in view of further use of energy and matching of current and/or voltage. Likewise an inverter may be provided.

In an example the (photo)voltaic system further comprises at least one second electrical accumulator, preferably part of the WiPoT transmitter, such as a Li-ion accumulator and a capacitor. The accumulator can store electrical energy over a period of time, e.g. before releasing it on demand. The accumulator can be a state of the art product. Preferably the accumulator is optimised e.g. in terms of applied voltage, current, output, loading, capacity, costs, charging time, etc.

In an example of the (photo)voltaic system the harvesting module comprises one or more transistors, preferably one or more FETs, wherein the one or more transistors operate at maximum power point, e.g. having a limited operating voltage range, such as from 0.75-1.25 V, preferably from 0.9-1.1 V, such as from 0.95-1.05 V. In an alternative an operating voltage range is chosen to be 0.25-0.75 V, preferably from 0.4-0.6 V, such as 0.5V. In the claims said voltage (or voltage range) is also referred to as first voltage. For instance a MOSFET, a JFET, and the like may be used. An advantage thereof is that it can operate at much lower current and/or voltage, thereby reducing e.g. energy losses.

In an example of the (photo)voltaic system comprises at least one voltaic multiplying current converter (VMC²) module per voltaic unit, each module comprising at least two IC³ circuits in series.

In an example of the (photo)voltaic system provides a) a variable voltage and a constant current having at least two voltaic units in series or for provides (b) a variable current and a constant voltage having at least two voltaic units in parallel, or combinations thereof. Therewith a degree of flexibility is introduced, which flexibility can be used in view of output requirements.

In an example of the (photo)voltaic system the controller is adapted to sample the one or more (photo)voltaic units, preferably at a predetermined first frequency, more preferably at a first frequency of 100-100.000 Hz, such as 500-50.000 Hz, preferably at 1-3 kHz, depending on system characteristics. By sampling an actual status of a cell or unit can be obtained, thereby providing e.g. further optimisation options. Preferably the sampling is performed at a relatively high frequency, providing an actual status e.g. more than once per second.

In an example the controller connects the one or more (photo)voltaic units to one of the one or more first charge siphon devices, preferably at a predetermined second frequency, preferably at a modulated second frequency, preferably a sinusoidal frequency of more than 25 kHz. In an example more than 100 kHz is used. Thereby electrical energy is transferred to the siphon devices before reaching a maximum capacity. Even further the siphon devices can as a consequence be relatively small.

In an example the controller comprises a maximum power point tracker. Therewith energy transfer can be optimised. As input for the maximum power point tracker voltage and electrical current can be taken. Also light intensity may be used in this respect. Typically a calibration curve of light intensity versus voltage, electrical current and power can be obtained or can be made available. Based on light intensity and/or voltage or the like energy harvesting can start or end. Sampling at a variable or constant frequency of relevant parameters may assist the maximum power point tracker, and likewise a controller.

In an example of the (photo)voltaic system the controller comprises a switching device, and/or wherein the controller comprises an optimiser. Therewith e.g. output can be optimised. In principle at least one switch per PV-unit is provided. However, one switch may also be in connection with more than one PV-unit, such as a multiplexer. In principle as many switches are provided as deemed necessary in order to provide flexibility, e.g. under various (weather) conditions, maximum power, constant voltage or constant current, etc.

In an example of the (photo)voltaic system a capacitance of the (photo)voltaic unit is 0-50% smaller than a capacitance of one of the one or more voltage adders, and/or wherein the one or more charge siphon devices comprise one or more accumulators, such as capacitors, wherein preferably the one or more electrical accumulators have a capacitance of more than 10 times the capacitance of the one or more voltage adders, preferably of more than 100 times, more preferably of more than 500 times, even more preferably of more than 1000 times, and/or wherein the one or more electrical accumulators operate in an operating voltage range of 1-10 V.

In an example of the (photo)voltaic system further comprises a means for storage of energy.

In an example the chamber of the photovoltaic system relates to a substantially closed container, having a certain volume. A typical height of the chamber is from 0.5-2.0 mm, preferably about 1 mm. The chamber is provided at a top side and bottom side thereof with a transparent closure, such as a glass plate, a polycarbonate plate, or the like. A typical thickness of a closure is from 1 mm-3 mm each. The closure provides strength to the chamber and system. The closure is in an example more than 90% transmittance (to light), such as Planibel Clear (3 mm) of AGC Europe. Other characteristics of such a closure material are considered relevant as well.

In an example a number of systems is contacted in series and/or parallel. Typical numbers are from 1-1000, such as 2-500, such as 10-250, e.g. 72, 100 and 144.

The present chamber comprises a first and second component. Typically a first component is a solid and a second component is a liquid. An example of a solid is TiO₂. An example of a liquid is a solution comprising a dye. As such the present system provides a huge range of colours, as dyes may be mixed into a required and/or desired colour. Such is very attractive for e.g. buildings.

The number of systems may be provided with different colours per system, or varying colours. As such patterns may be formed, such as a rainbow, a logo of a firm, a mosaic like painting etc. Therefore the present system allows for variation in appearance and in principal any 2-dimensional figure may be formed.

The present system and product also provide for many different designs, e.g. in terms of 3-D structure. Therein also further elements may be provided, such as internal or external reflective coatings, such as a mirror. Also a one-sided mirror may be provided, being transparent from one side, e.g. an inner side, and reflective on another side.

Due to presence of the second component and possibly also the first component the chamber has at least 20% optical transmittance, preferably at least 30% optical transmittance. It is preferred to have some light transmitted through the system, as the system typically also functions as a building element. As such the system may also function as a screen, not allowing (sun) light to pass through. Such integration of functions clearly limits total costs involved, e.g. of decorating a building.

Typical dimension of a contact in a DSC are a width of 0.1-2 mm, such as 0.5-1 mm, a thickness of 5-1000 μm, such as 25-500 μm, such as 50-250 μm. Typically at least one contact meanders through the chamber, in order to minimize a distance between a location where electrons are formed (in the liquid) and contact.

In an example of the DSC the first and/or second contact form an elongated structure. Therewith output is further increased.

In an example the DSC further comprises means for refracting light, which means direct light away from the first and/or second contact towards the first and second component. Therewith the amount of PV-material relative to e.g. a surface area of the DSC can be minimised, thereby minimising costs and meanwhile maintaining output.

The photovoltaic unit may also be a monocrystalline or polycrystalline silicon unit or the like. In an example the one or more photovoltaic units are selected from single junction and multi junction semiconductor PV-units, such as Si-units, III-IV-units, thin film solar units, such as CdTe, CuInGaSe, GaAs, organic units, polymer units, dye solar units, back contact systems, and combinations thereof. In an example a back contact system and the present cell current converter are combined. The present invention provides possibilities to optimise the present photovoltaic unit e.g. in terms of appearance, output, functionality, etc.

Also combinations of the above features for voltaic cells are envisaged.

In a second aspect the present invention relates to a product, such as building integrated photo voltaic (BIPV) element, a building applied photo voltaic (BAPV) element, an off-grid system, a solar farm, a Voltaic element, electrical accumulator, chip, mobile phone, device, roof-tile, appliance, game, trademark, brand name, timer, remote control, picture, logo, graphics, stand-alone system, and combinations thereof, comprising a Voltaic system according to the invention.

For a building integrated element the present product may also function as or include means for thermal and/or sound insulation. Even further, the present product may be used to create a space between e.g. an inner wall and the product, the space functioning as insulation. The space may be filled with insulation material as well. The present product may be in any required form, such as substantially flat, undulated, curved, and combinations thereof.

Within the present system or product PV-cells- and units may be placed in series, in parallel, and combinations thereof.

The present system and product provide for decentralised generation and storage of energy, e.g. in a neighbourhood. Such is particularly efficient in terms of energy losses, e.g. as when using a power grid energy losses for transport are quite significant.

The present system and product are e.g. provided in standard sizes. When applying the present system and or product when redecorating or building new homes an energy supply is provided at relatively low extra costs. As a consequence the present invention is applicable in any situation were voltaic energy can be harvested from e.g. sunlight, i.e. also at sub-optimal locations in terms of amount of sunlight received, such as partly in the shadow, on north and east side of a building (northern hemisphere) etc.

In an example the product comprises a means for storage of energy, and/or comprising two or more wireless power transmitters, preferably connected parallel, and/or comprising one or more Intelligent cell current converters (IC³) circuits and/or one or more voltaic multiplying current converter (VMC²) modules.

In an example the product or building element further comprises domotica. Therewith demand and supply can be optimised, e.g. in terms of amount stored, capacity of components, etc.

In an example the present product is adapted to be used in series and/or in parallel, such as a roof-tile, a PV-unit, and in a grid.

In an example the present product has a random size, and/or wherein the product has a regular shaped size, such as rectangular, circular, multigonal, such as hexagonal, and octagonal, and/or wherein the product is curved. A random size allows production and application of the present product at any (given) location. The present product may also follow a curvature of a given location, such as a roof tile.

The present invention relates also to a technological object comprising a (photo)voltaic system according to the invention.

In a third aspect the present invention relates to a use of the present (photo)voltaic system or a present product for improving output of a (photo)voltaic system.

In further aspects the present invention relates to an Intelligent cell current converter (IC³) circuit and to a voltaic multiplying current converter (VMC²) modules, which circuits and module have a multitude of electrical applications.

The invention is further detailed by the accompanying figures, which are exemplary and explanatory of nature and are not limiting the scope of the invention.

### BRIEF DESCRIPTION OF THE FIGURES

FIG. 1a-g show schematical lay-outs of a VMC² module and IC3 technology.

FIG. 2 shows a schematical lay-out of a VMC² module and a WiPoT.

FIG. 3 shows a present configuration.

FIG. 4 shows an example of the present WiPoT.

### DETAILED DESCRIPTION OF THE FIGURES

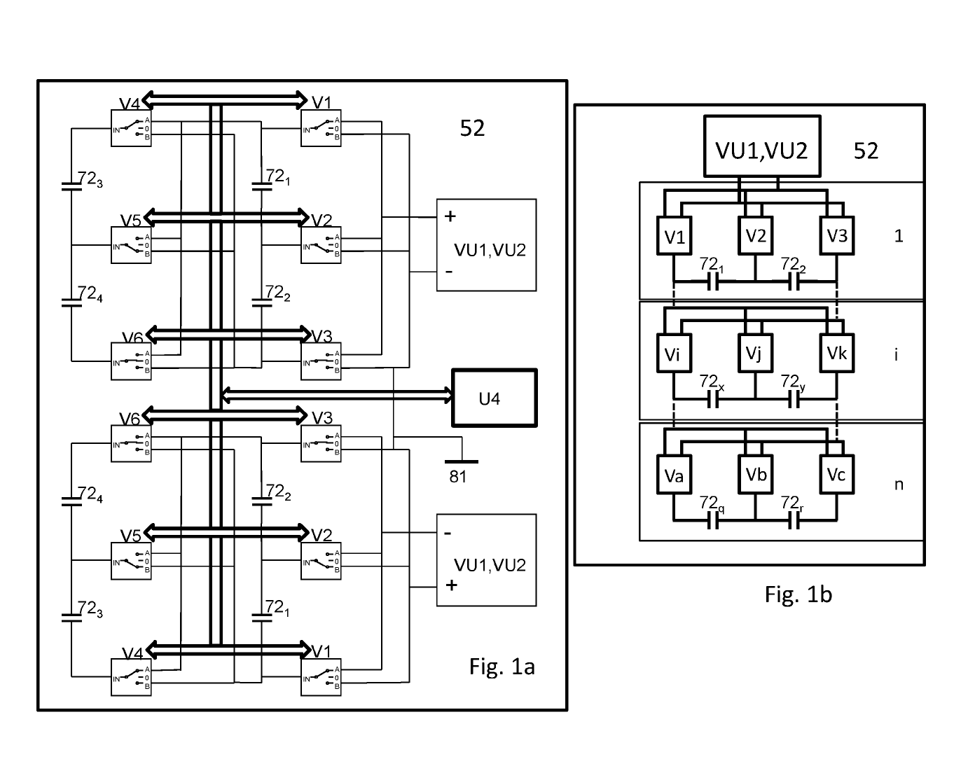

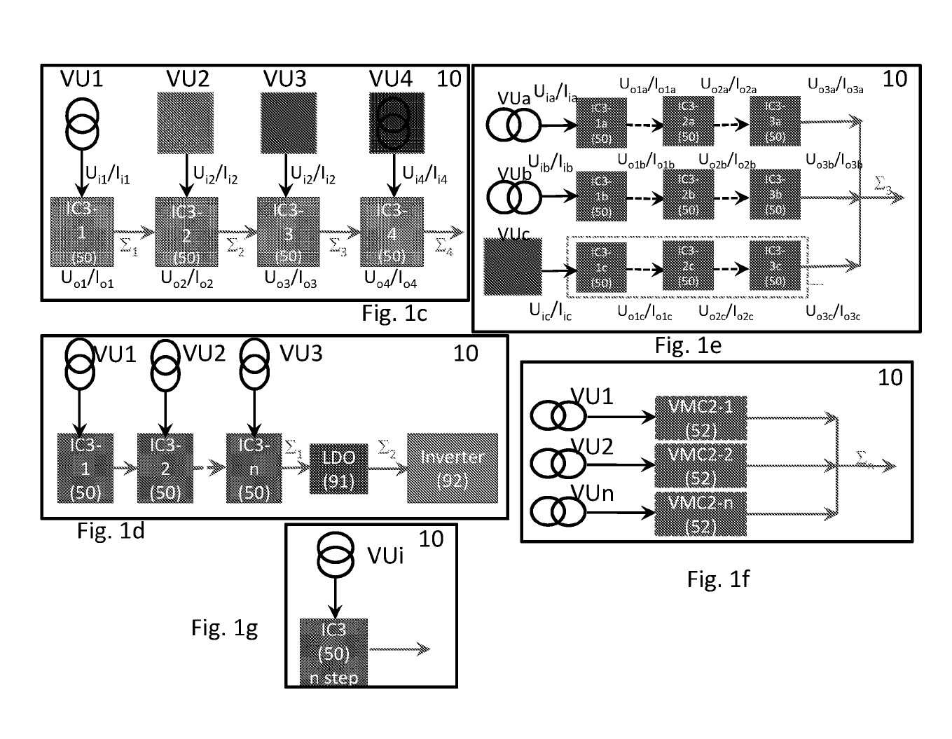

In FIG. 1a two PV-cells are provided forming one PV-unit (VU1, VU2). The PV-unit is connected to a first series of switches (V1,V2,V3). The switch may be in one of three positions, indicated with A, 0 (neutral) and B. By alternating setting of these switches capacitors (72₁,72₂) are loaded. In FIG. 1a further a controller U4 is provided. Communication with switches (V1,V2,V3) can be provided by a bus or the like. Communication can be wireless, by electrical current and by magnetic field, and a combination thereof. In the example two capacitors are shown. In principle two or more capacitors may be used, such as 3-10 in series. It is preferred to use 2 capacitors, in view of optimal yield. The present system increases power and reduces current, therewith reducing losses during transport. The present system uses preferably Maximum PowerPoint Tracking, preferably at a chosen voltage of e.g. 0.5V. Preferably the VMC² is provided in a chip. As such one chip per PV-cell may be provided. The chips may be interconnected, either in series, preferably in parallel. An advantage of the present invention is that if one PV-cell does not provide output or a significantly reduced output, the system as a whole provides almost the same output as before, contrary to prior art systems.

In FIG. 1b a VMC² module (50) comprises a series of 1, . . . i, . . . n switches (V1,V2,V3;Vi,Vj,Vk;Va,Vb,Vc) and capacitors (72₁,72₂;72ₓ,72_{y};72_{q}, 72ᵣ). The example shows only three (1,i,n) out of n switches and capacitors.

In FIG. 1c four voltaic units (VU1-VU4) are shown connected in series. The three units on the right are not functioning fully, e.g. due to shading. As a consequence the output is in the example limited to about 50% to 4 A (second unit), 75% to 2 A (third unit), and 12.5% to 1 A (fourth unit) (compared to 8 A for the unit on the left). All units operate in the example at about 0.5 V. By providing IC3 (50) technology to each voltaic unit the current is kept constant (to 1 A in the example), whereas the voltage is added, from 4V towards 6V, 7V and 7.5V on the right, respectively. The most right unit is considered limiting, e.g. providing only 1 A. The IC³-4 provides a (1 step) multiplication/division of 1 (equal). The output voltage Uₒ₄=Uᵢ₄×1 (0.5V) and the output current is Iₒ₄=Iᵢ₄/1 (1 A). As a consequence the IC³-3 provides a (2 step) multiplication/division of 2. The output voltage Uₒ₃=Uᵢ₃×2 (1.0V) and the output current is Iₒ₃=Iᵢ₃/2 (1 A). As a consequence the IC³-2 provides a (4 step) multiplication/division of 4. The output voltage Uₒ₂=Iᵢ₂×4 (2.0V) and the output current is Iₒ₂=Iᵢ₂/4 (1 A). As a consequence the IC³-1 provides a (8 step) multiplication/division of 8. The output voltage Uₒ₁=Uᵢ₁×8 (4.0V) and the output current is Iₒ₁=Iᵢ₁/8 (1 A). The summed voltages Σᵢ are from left to right 4.0V, 6.0V, 7.0V and 7.5V, respectively, at a constant current of 1 A. Therewith the system as a whole is electrically balanced. Herein power is collected per cell and bundled in series.

In FIG. 1d the present n voltaic units having each one IC3 circuit further comprise a module for converting a constant current and variable voltage Σ₁ to a variable current and a constant voltage Σ₂, such as a low drop out (LDO) module (91), and an inverter (92).

In FIG. 1e three voltaic units (VU) are connected in parallel. One (the lower) voltaic unit is partly shaded, and as a consequence providing less current (Iᵢⱼ; 4 A compared to 8 A for the top two), all at 0.5V (Uᵢⱼ). Each voltaic unit has a series of IC³'s, (50) in the example 3. The IC³1a,b,c multiply the voltage by a factor 4 and divide the current by a factor 4, providing an output Uₒ₁ₐ=Uᵢ₁ₐ×4 (same for b,c), and a output Iₒ₁ₐ=Iᵢ₁ₐ/4 (same for b,c), whereas for IC³2a,b,c and IC³3a,b,c the factor is 2, providing an output Uₒ₂ₐ=Uᵢ₂ₐ×2 (same for b,c), and a output Iₒ₂ₐ=Iᵢ₂ₐ/2 (same for b,c) (an same for IC³3a,b,c). The final output is 8V and 1.25 A (Σ₃). It is noted that in principle any factor may be chosen, the factor typically being an integer, such as 2, 3, 4, 5, 6, 8 etc. Typically a factor 2ⁿ is chosen, n typically being ε[1,10]. It is preferred to optimise a maximal power output. In a preferred example the factor is 2. Herein power is collected per cell and bundled in parallel. As a result a constant voltage and a variable output are provided.

In FIG. 1f FIG. 1e is presented somewhat different. Therein each VMC² (52) comprises in the example 3 IC³'s. The number of IC³'s per VMC² may vary from a minimum of 1 to about 10, such as 2-8, preferably 3 or 4.

As such the present options of connecting cells in series or in parallel provide a possibility of generating constant current or constant voltage and collecting power fully. Of course combinations of parallel and series are envisaged. As a consequence not fully functioning voltaic units do not hinder power harvesting; in fact all or almost all energy is harvested. Even further also at very low power output energy is harvested, contrary to prior art systems.

In FIG. 1g a principle of the present IC3 circuit is presented. Therein current is divided and voltage is multiplied in n steps. As a consequence Uₒ₁=Uᵢ₁×n and Iₒ₁=Iᵢ₁/n, the multiplication/division factor being n. For instance n may be 2, the factor as a consequence being 2, etc.

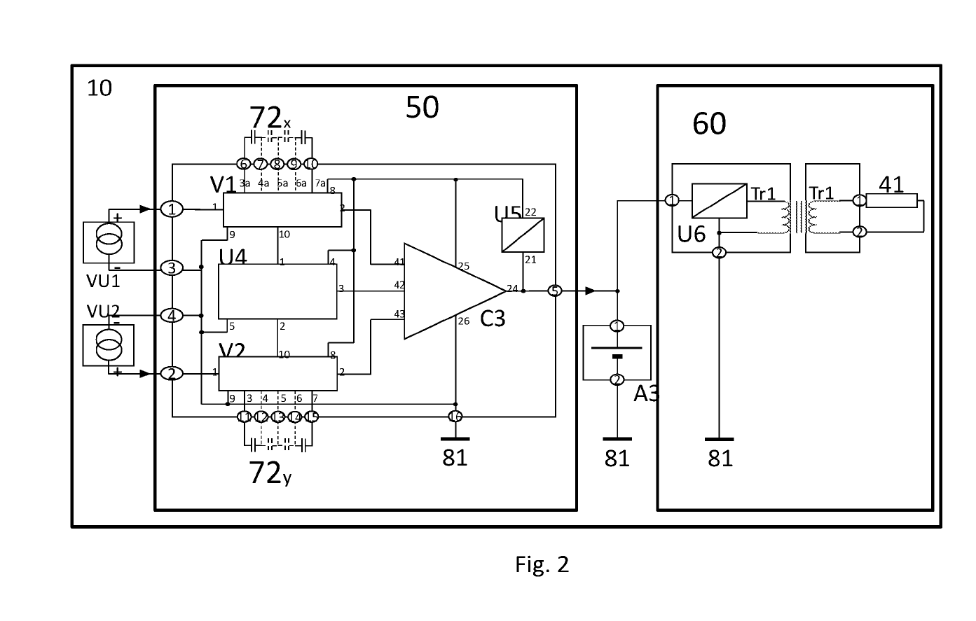

In FIG. 2 two PV-cells are provided forming one PV-unit (VU1, VU2). A current in maximum power point for VU1 is Iₘₚₚ₁=Uₘₚₚ₁/Rₓ, and for VU2 is Iₘₚₚ₂=Uₘₚₚ₂/Rₓ. The cells are connected to an optional voltaic multiplying current converter module (50). A voltage adder (V1, V2) connects the PV-cell to two or more harvesting capacitors (72), or is switched off (open). The output current of the voltage adder U1 is Iₒᵤₜ₁=n×Uₘₚₚ₁/Rₓ, for U2 is Iₒᵤₜ₂=n×Uₘₚₚ₂/R_{y}, wherein n is the number of capacitances, taking all capacitances are equal. Also a microcontroller (U4) is provided, typically comprising a processor. Switching and harvesting can be optimised by using a modulated frequency. As such every cell can be treated as a unique cell, having specific characteristics. When switching preferably also the ground is switched at the same time. The capacitance of the harvesting capacitor is preferably about 10% smaller than the capacitance of the PV-cell. When switching the capacitance of a PV-cell is connected to the capacitance of one of the harvesting capacitors, and typically then switched to another harvesting capacitance. Further a current adder (C3), providing a current Iₒᵤₜ₁+Iₒᵤₜ₂, connects the voltage adders to a wireless power transmitter (60). Optionally a Li-ion accumulator (A3) is provided, e.g. a 3.7 V 650 mA battery, as well as a VMC2-power supply (U5). A current of I_{chrg}=U_{accu}/R_{z} is provided to the WiPoT. The wireless power transmitter comprises a primary (Tr1) and a secondary (Tr2) winding. Optionally a WiPoT generator (U6) is provided. Further the secondary winding is connected to a load resistance (41), or to the power grid, or to a further accumulator, such as a battery pack, e.g. having a 3-5 kW storage capacity. Optionally the WiPoT is idle.

In an example a coil is used with an inductance of <4000 nH, preferably 400-600 nH. In an example a gap in the transformer is smaller than 250 μm, preferably smaller than 50 μm, such as smaller than 10 μm. As such magnetic field lines have been found to be trapped inside the transformer.

The PV-unit may be connected to domotica, e.g. a computer. Power storage, consumption, usage pattern, etc. can thereby be optimised with respect to one and another.

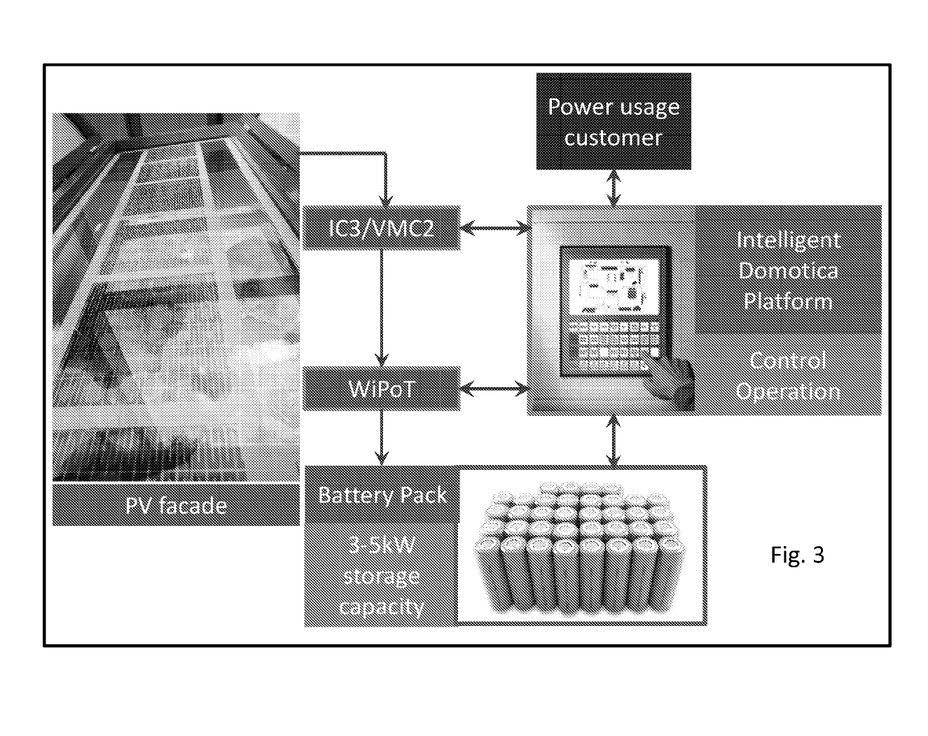

In FIG. 3 a schematic representation of a present system including a VMC², a WiPot, Domotica, PV-units, a storage, and electrical grid is shown.

In an example the present systems have an electrical conversion efficiency of 97% or more in an operating range of 0.001-4 W. In an example a voltage of 0.5 V, quite typical for a PV-system, is converted to 2 V. A sampling frequency may be fixed, and may be regulated automatically.

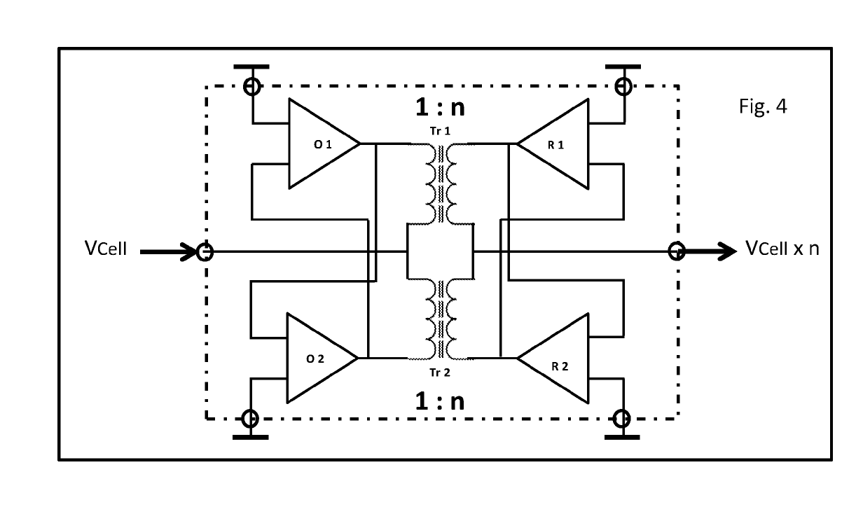

FIG. 4 shows an example of the present WiPoT. Therein at a left side a voltage V_{cell} is provided, such as by a solar cell. Two oscillators, O1 and O2, such as voltage controlled oscillators, are used to control the two transformer Tr1 and Tr2. In an example a first transformer, e.g. Tr1, may be used to transform a positive part of the sinusoidal signal, whereas a second transformer, e.g. Tr2, may be used to transform a negative part of the sinusoidal signal. The transformers have a multiplication factor of n, such as 2, 4, 8 etc. Two rectifiers, R1 and R2, are used to provide a direct current. As a result an output potential of n times the cell potential is provided.

What is claimed is:

1. Voltaic system (10) for optimizing output in terms of electrical energy comprising
at least two voltaic units (VU1, VU2), the voltaic units being electrically coupled, wherein each voltaic unit is capable of operating at one first voltage and at one or more first currents,
at least one Intelligent cell current converter (IC³) circuit (50), an IC³ circuit multiplying the first voltage by a first factor and dividing the one or more first currents by the first factor, and optionally one or more of a wireless power transmitter (WiPoT) (60) and an electrical accumulator (A3), preferably at least one circuit and at least one wireless transmitter per unit,
the Intelligent cell current converter (IC³) circuits comprising
(i) one or more (n) voltage adders (V1, V2) and optionally one or more current adders (C3), the one or more current adders being adapted to be in electrical connection to the one or more voltage adders
(ii) two or more first charge siphon devices (72) per voltage adder, preferably 2-100 siphon devices per voltage adder, such as 4-50 siphon devices per voltage adder, wherein the two or more first siphon devices are electrically connected in series to one and another, wherein the two or more first charge siphon devices are adapted to be in electrical connection with the one or more voltage adders, and wherein the one or more charge siphon devices comprise one or more capacitors,
(iii) one or more switches for electrically connecting or disconnecting components of the voltaic system, and
(iv) a comparator (U4),
the wireless power transmitter (60) comprising
a primary winding (Tr1), a secondary winding (Tr2), and optionally a generator/oscillator (U6),
wherein the primary winding is adapted to be electrically coupled to the one or more voltaic units,
wherein the secondary winding is adapted to be electrically coupled to one or more of a load device and power grid, and
wherein the one or more voltaic units, the at least one Intelligent cell current converter (IC³) circuit, and wireless power transmitter are adapted to be in electrical contact with one and another.

2. Voltaic system according to claim 1, adapted to be attached to a surface or forming part thereof, wherein the voltaic unit is a photovoltaic unit, each unit independently comprising 1-10 photovoltaic cells, preferably 1-5 photovoltaic cells, such as 2-4 photovoltaic cells.

3. Voltaic system according to claim 1, wherein the (IC³) circuit further comprises one or more of a power supply (U5), a controller, a timer, a collector cell, a display, a module for converting a constant current and variable voltage to a variable current and a constant voltage (91), such as a low drop out (LDO) module, an inverter (92), and a processor, and/or wherein the (IC³) circuit comprises 2^{m} charge siphon devices, wherein m is selected from {2;10}, preferably from {3;9}, such as {4;8}.

4. Voltaic system according to claim 1, wherein the WiPoT transmitter further comprises at least one second electrical accumulator (41), such as a Li-ion accumulator and a capacitor.

5. Voltaic system according to claim 1, wherein the (IC³) circuit comprises one or more transistors, preferably one or more FETs, wherein the one or more transistors operate at maximum power point, e.g. having an limited operating voltage range, such as from 0.75-1.25 V, preferably from 0.9-1.1 V, such as from 0.95-1.05 V, or from 0.25-0.75 V, preferably from 0.4-0.6 V, such as 0.5V.

6. Voltaic system according to claim 1, comprising at least one voltaic multiplying current converter (VMC²) module (52) per voltaic unit, each module comprising at least two IC³ circuits in series.

7. Voltaic system according to at least one of the preceding claims, for providing (a) a variable voltage and a constant current having at least two voltaic units in series or for providing (b) a variable current and a constant voltage having at least two voltaic units in parallel, or combinations thereof.

8. Voltaic system according to claim 3, wherein the controller is adapted to sample the one or more voltaic units, preferably at a predetermined first frequency, more preferably at a first frequency of 100-100.000 Hz, such as 500-50.000 Hz, preferably from 1-3 kHz, and/or wherein the controller connects the one or more voltaic units to one of the one or more first charge siphon devices, preferably at a predetermined second frequency, preferably at a modulated second frequency, preferably a sinusoidal frequency of more than 25 kHz, and/or wherein the controller comprises a maximum power point tracker (MPPT), and/or
wherein the controller comprises a switching device, and/or wherein the controller comprises an optimiser.

9. Voltaic system according to claim 1, wherein the one or more voltaic units are selected from single junction and multi junction semiconductor PV-units, such as Si-units, III-IV-units, thin film solar units, such as CdTe, CuInGaSe, GaAs, organic units, polymer units, dye solar units, back contact systems, and combinations thereof, and/or
wherein a capacitance of a voltaic unit is 0-50% smaller than a capacitance of one of the one or more voltage adders, wherein preferably the one or more electrical accumulators have a capacitance of more than 10 times the capacitance of the one or more voltage adders, preferably of more than 100 times, more preferably of more than 500 times, even more preferably of more than 1000 times, and/or wherein the one or more electrical accumulators operate in an operating voltage range of 1-10 V.

10. Product, such as building integrated photo voltaic (BIPV) element, a building applied photo voltaic (BAPV) element, an off-grid system, a solar farm, a Voltaic element, electrical accumulator, chip, mobile phone, device, roof-tile, appliance, game, trademark, brand name, timer, remote control, picture, logo, graphics, stand-alone system, and combinations thereof, comprising a Voltaic system according to claim 1, and
optionally comprising a means for storage of energy, and/or comprising two or more wireless power transmitters, preferably connected parallel, and/or comprising one or more Intelligent cell current converters (IC³) circuits and/or one or more voltaic multiplying current converter (VMC²) modules, and
optionally comprising domotica.

11. Product according to claim 10, wherein the product is adapted to be use in series and/or in parallel, such as a roof-tile, a PV-unit, and in a grid, and/or wherein the product has a random size, and/or wherein the product has a regular shaped size, such as rectangular, circular, multigonal, such as hexagonal, and octagonal, and/or wherein the product is curved.

12. Building comprising one or more Voltaic systems according to any of claim 1 or one or more products according to claim 11.

13. Use of a Voltaic system according to any of claim 1 or a product according to claim 10 for improving power output of a Voltaic system.

14. Intelligent cell current converter (IC³) circuit for optimizing output in terms of electrical energy and for use in a voltaic system, the Intelligent cell current converter (IC³) circuit comprising
(i) one or more (n) voltage adders (V1, V2) and optionally one or more current adders (C3), the one or more current adders-being adapted to be in electrical connection to the one or more voltage adders,
(ii) two or more first charge siphon devices (72) per voltage adder, preferably 2-100 siphon devices per voltage adder, such as 4-50 siphon devices per voltage adder, wherein the two or more first siphon devices are electrically connected in series to one and another, wherein the two or more first charge siphon devices are adapted to be in electrical connection with the one or more voltage adders, and wherein the one or more charge siphon devices comprise one or more capacitors,
(iii) one or more switches for electrically connecting or disconnecting components of the voltaic system, and
(iv) a comparator (U4).

15. A voltaic multiplying current converter (VMC²) module (80) comprising two or more Intelligent cell current converter (IC³) circuit according to claim 14 in series.
